(19) United States
(12) Patent Application Publication
(10) Pub. No.: US 2023/0141629 A1
(43) Pub. Date: May 11, 2023

(54) ELECTRIC JACK WITH CURRENT LIMITING PROTECTOR

(71) Applicant: Hangzhou Henghong Machinery Co., Ltd., Hangzhou (CN)

(72) Inventors: Guozhong WANG, Hangzhou (CN); Jiangqiang LU, Hangzhou (CN); Feng TIAN, Hangzhou (CN); Yike LUO, Hangzhou (CN); Ming LU, Hangzhou (CN); Jinming SHI, Hangzhou (CN); Yafeng HU, Hangzhou (CN); Lingling WANG, Hangzhou (CN); Qunfang WANG, Hangzhou (CN)

(73) Assignee: Hangzhou Henghong Machinery Co., Ltd., Hangzhou (CN)

(21) Appl. No.: 17/674,661

(22) Filed: Feb. 17, 2022

(30) Foreign Application Priority Data
Nov. 5, 2021 (CN) 202111303498.5

(51) Int. Cl. B66F 17/00; H02H 9/02; B66F 3/44

(52) U.S. Cl. CPC B66F 17/00; H02H 9/02; B66F 3/44

(57) ABSTRACT

The present disclosure provides an electric jack with a current limiting protector, which relates to the technical field of mechanical equipment. The electric jack with the current limiting protector includes: a current limiting protector, a four-pin double-reset switch, a control motor, and a supporting leg main body. The current limiting protector is connected in parallel to the control motor through the four-pin double-reset switch. The current limiting protector, the four-pin double-reset switch, and the control motor are detachably mounted on the supporting leg main body. A first wiring terminal, a second wiring terminal, a third wiring terminal, a fourth wiring terminal, a fifth wiring terminal, and a current limiting protection circuit are distributed on the current limiting protector.

### CROSS REFERENCE TO RELATED APPLICATION(S)

This patent application claims the benefit and priority of Chinese Patent Application No. 202111303498.5, filed on Nov. 5, 2021, the disclosure of which is incorporated by reference herein in its entirety as part of the present application.

### TECHNICAL FIELD

The present disclosure relates to the technical field of mechanical equipment, and in particular, to an electric jack with a current limiting protector.

### BACKGROUND ART

Jacks are lifting tools arranged for jacking, most of which are conventional manual screw or hydraulic jacks. When an electric jack operates, the current of a motor will increase due to overload or over stroke and the motor may also be burnt out due to severe heating of the motor. Meanwhile, other parts of the jack may also be damaged due to overload, which results in potential safety hazards. Mechanical hard blockage will be caused due to over stroke, which will also increase the current of the motor to damage the motor within a short time. In addition, due to an impact force generated during motor stalling, a weak spot of a mechanical structure will be damaged, or the mechanical structure will be stuck.

The existing electric jack protects the parts of the jack from being damaged by adopting a limit switch or a self-reset over-current protector. The limit switch is relatively high in limiting cost and complex in circuit, which is often prone to program error to cause control failure. The principle of the self-reset over-current protector is that an internal elastic piece generates heat due to the increase of current. The elastic piece deforms and leaves a contact to trip power-off protection. The elastic piece self-resets to be in contact with the contact to electrify after cooling. After over-current, the power-off time is relatively long, which cannot realize power-off protection in a short time. In addition, the reset time is long, and after repeated use, the limited current magnitude will also attenuate quickly and cannot be used frequently.

### SUMMARY

The problem solved by the present disclosure is how to overcome the damage to parts of an electric jack caused by the operation overload of a motor, thereby prolonging the service life of the electric jack.

In order to solve the above problem, the present disclosure provides an electric jack with a current limiting protector, including a current limiting protector, a four-pin double-reset switch, a control motor, and a supporting leg main body.

The current limiting protector is connected in parallel to the control motor through the four-pin double-reset switch. The current limiting protector, the four-pin double-reset switch, and the control motor are detachably mounted on the supporting leg main body.

A first wiring terminal, a second wiring terminal, a third wiring terminal, a fourth wiring terminal, a fifth wiring terminal, and a current limiting protection circuit are distributed on the current limiting protector.

The first wiring terminal is connected to a negative electrode of the four-pin double-reset switch.

The second wiring terminal is grounded.

The third wiring terminal is connected to an input end of a power supply in parallel with a positive electrode of the four-pin double-reset switch.

The fourth wiring terminal and the fifth wiring terminal are respectively connected to the control motor.

The current limiting protection circuit is configured to perform overload power-off protection on the control motor.

In the above structure, over-current protection is performed on an operating current during operating of the electric jack through the current limiting protector. A current limiting action can be realized within an extremely short time through the current limiting protection circuit on the current limiting protector, which avoids the damage to internal parts of the electric jack due to operation overload, and prolongs the service life of the electric jack. The first wiring terminal, the second wiring terminal, the third wiring terminal, the fourth wiring terminal, the fifth wiring terminal, and the current limiting protection circuit are distributed on the current limiting protector, so that the wiring terminals are integrated and arranged on the current limiting protector, which facilitates the connection between the four-pin double-reset switch and the control motor, and reduces the space occupied by modules on the electric jack.

Further, the current limiting protection circuit includes an operational amplifier chip, a first operational amplifier circuit, a second operational amplifier circuit, a four-pin control circuit, a photoelectric isolation circuit, and a voltage stabilizing circuit.

The operational amplifier circuit and the second operational amplifier circuit are configured to buffer signal loss generated by output impedance.

The four-pin control circuit control circuit is configured to control the on/off of the four-pin double-reset switch.

The photoelectric isolation circuit is configured to suppress noise between the four-pin control circuit and the control motor, and eliminate the interference of a ground loop.

The voltage stabilizing circuit is configured to stabilize an input voltage.

Further, a first pin, a second pin, and a third pin of the operational amplifier chip form a first operational amplifier channel.

The first operational amplifier circuit consists of the first operational amplifier channel, a sixth resistor, an electric control switch, a second diode, a fifth resistor, a seventh resistor, an eighth resistor, an eleventh resistor, a second capacitor, a third capacitor, and a fourth capacitor.

The fifth resistor is connected in parallel between a first pin and a second pin of the operational amplifier chip. The sixth resistor, the seventh resistor, the eighth resistor, the eleventh resistor, the second capacitor, the third capacitor, and the fourth capacitor are connected in parallel to the digital ground through the first operational amplifier channel.

The sixth resistor is connected in parallel with a first pin of the electric control switch. A second pin of the electric control switch is connected in parallel with power ground. The electric control switch is connected to the supply voltage in parallel with the second diode through a fourth pin and a fifth pin, where the sixth resistor is a sampling resistor.

In the above structure, the electric control switch is an electric control device, which makes the controlled quantity change in a predetermined step in an electrical output circuit when the change of an input quantity meets a specified requirement. The electric control switch has an interactive relationship between an input loop and an output loop. The electric control switch is an “automatic switch” that usually operates. The electric control switch achieves the functions of automatic adjustment, safety protection, circuit conversion, and the like.

Further, a fifth pin, a sixth pin, and a seventh pin of the operational amplifier chip form a second operational amplifier channel.

The second operational amplifier circuit consists of the second operational amplifier channel, the third resistor, a fifth capacitor, and a sixth capacitor. One end of the third resistor is connected in parallel to the first pin of the operational amplifier chip and the fifth resistor. The other end of the third resistor is connected to the digital ground in parallel with the fifth pin of the operational amplifier chip and the fifth capacitor. The seventh pin of the operational amplifier chip is connected to the digital ground in parallel with the sixth capacitor.

In the above structure, in the operational amplifier chip, the first pin is an output end. The second pin is an inverting input end. The third pin is a non-inverting input end. The fourth pin is a negative power supply. The fifth pin is a non-inverting input end. The sixth pin is an inverting input end. The seventh pin is an output end. The eighth pin is a supply voltage. When a voltage at the non-inverting input end is higher than that of the inverting input end, the output is a high level. When the voltage at the non-inverting input end is lower than that of the inverting input end, the output of a voltage comparator is a low level.

Further, the four-pin control circuit is connected to the first operational amplifier channel and the second operational amplifier channel.

The four-pin control circuit consists of a first triode, a second triode, a third triode, a fourth triode, the first resistor, the second resistor, the fourth resistor, a ninth resistor, a tenth resistor, a twelfth resistor, a fifteenth resistor, a sixteenth resistor, an eighteenth resistor, a first diode, a third diode, a fourth diode, the first capacitor, and a seventh capacitor.

An emitting electrode of the first triode is connected to the supply voltage in parallel with one end of the first capacitor and one end of the fourth resistor. A sixth pin of the operational amplifier chip, a collecting electrode of the first triode, the fourth diode, the twelfth resistor, the other end of the first capacitor, and the other end of the fourth resistor are connected in parallel to the digital ground. A base electrode of the first triode is connected in parallel with a collecting electrode of the fourth triode and the eighteenth resistor.

An emitting electrode of the fourth triode is connected to the supply voltage in parallel with one end of the fifteenth resistor. A base electrode of the fourth triode is connected in parallel to the other end of the fifteenth resistor through the sixteenth resistor.

A collecting electrode of the second triode is connected in parallel with each of the second resistor and a base electrode of the third triode. A base electrode of the second triode is connected to the digital ground in parallel with a negative electrode of the first diode, a negative electrode of the third diode and the seventh capacitor through the tenth resistor. A positive electrode of the first diode is connected to the power ground in series with the first resistor. A positive electrode of the third diode is connected in parallel to the seventh pin of the operational amplifier chip.

A collecting electrode of the third triode is connected to the supply voltage in parallel with the electric control switch and the second diode. An emitting electrode of the third triode is connected to the digital ground in parallel with an emitting electrode of the second triode.

Further, the photoelectric isolation circuit consists of a first photoelectric coupler, a second photoelectric coupler, a sixth diode, a seventh diode, a fourteenth resistor, a seventeenth resistor, the ninth capacitor, and the tenth resistor.

A fourth pin of the first photoelectric coupler is connected in parallel to the other end of the fifteenth resistor, the other end of the sixteenth resistor, and a fourth pin of a second photoelectric coupler. A third pin of the first photoelectric coupler is connected to the digital ground in parallel with a third pin of the second photoelectric coupler and the eighteenth resistor. A second pin and a first pin of the first photoelectric coupler are connected to the control motor in parallel with the sixth diode, the ninth capacitor, and the fourteenth resistor.

A second pin and a first pin of the second photoelectric coupler are connected to the control motor in parallel with the seventh diode, a tenth capacitor, and the seventeenth resistor.

Further, the voltage stabilizing circuit consists of a fifth diode, an eighth capacitor, and a thirteenth resistor.

One end of the thirteenth resistor is connected to the input voltage. The other end of the thirteenth resistor is connected to the power voltage in parallel with a negative electrode of the fifth diode and a positive electrode of the eighth capacitor. A positive electrode of the fifth diode and a negative electrode of the eighth capacitor are connected in parallel to the digital ground.

In the above structure, the digital ground is a common reference ground wire with a zero potential of a digital circuit. The power ground is a common reference ground wire with a zero potential of a load circuit. Both the digital ground and the power ground achieve an effect of electrically isolating.

Further, the operational amplifier chip adopts an LM358 voltage follower.

In the above structure, a first pin, a second pin, and a third pin of the LM358 voltage follower form the first operational amplifier channel. A fifth pin, a sixth pin, and a seventh pin of the LM358 voltage follower form a second operational amplifier channel.

Further, the first triode and the fourth triode adopt PNP type triodes, and the second triode and the third triode adopt NPN type triodes.

Further, the supporting leg main body includes a mounting seat, a telescopic component, and a base.

The four-pin double-reset switch and the control motor are detachably mounted on the mounting seat of the supporting leg main body. The mounting seat is fixedly connected to the base through the telescopic component.

By adopting the technical solution above, the present disclosure has the following beneficial effects:

Over-current protection is performed on an operating current during operating of the electric jack through the current limiting protector. A current limiting action can be realized within an extremely short time through the current limiting protection circuit on the current limiting protector, which limits the current accurately, avoids the damage to internal parts of the electric jack due to operation overload, and prolongs the service life of the electric jack. Meanwhile, there is no need to protect the parts in terms of structural strength, and the strength requirements of supporting leg components are also reduced to some extent, thereby reducing the material cost of the electric jack.

### BRIEF DESCRIPTION OF THE DRAWINGS

FIG. 1 is a structural schematic diagram of an electric jack with a current limiting protector provided by an embodiment of the present disclosure;

FIG. 2 is a wiring diagram of a current limiting protector, a double-reset switch, and a control motor of the electric jack with the current limiting protector provided by the embodiment of the present disclosure;

FIG. 3 is a structural schematic diagram of the current limiting protector of the electric jack with the current limiting protector provided by the embodiment of the present disclosure;

FIG. 4 is a schematic diagram of a current limiting protection circuit of the electric jack with the current limiting protector provided by the embodiment of the present disclosure;

FIG. 5 is a schematic diagram of a first operational amplifier circuit of the electric jack with the current limiting protector provided by the embodiment of the present disclosure;

FIG. 6 is a schematic diagram of a second operational amplifier circuit of the electric jack with the current limiting protector provided by the embodiment of the present disclosure;

FIG. 7 is a photoelectric isolation circuit of the electric jack with the current limiting protector provided by the embodiment of the present disclosure; and

FIG. 8 is a schematic diagram of a voltage stabilizing circuit of the electric jack with the current limiting protector provided by the embodiment of the present disclosure.

### REFERENCE SIGNS IN THE DRAWINGS

1—current limiting protector, 101—first wiring terminal, 102—second wiring terminal, 103—third wiring terminal, 104—fourth wiring terminal, 105—fifth wiring terminal, 106—current limiting protection circuit, 2—four-pin double-reset switch, 3—control motor, 4—supporting leg main body, 401—mounting seat, 402—telescopic component, 403—base, U1—operational amplifier chip, R6—sixth resistor, K1—electric control switch, R1—first resistor, R2—second resistor, R3—third resistor, R4—fourth resistor, R5—fifth resistor, R7—seventh resistor, R8—eighth resistor, R9—ninth resistor, R10—tenth resistor, R11—eleventh resistor, R12—twelfth resistor, R13—thirteenth resistor, R14—fourteenth resistor, R15—fifteenth resistor, R16—sixteenth resistor, R17—seventeenth resistor, R18—eighteenth resistor, C1—firth capacitor, C2—second capacitor, C3—third capacitor, C4—fourth capacitor, C5—fifth capacitor, C6—sixth capacitor, C7—seventh capacitor, C8—eighth capacitor, C9—ninth capacitor, C10—tenth capacitor, Q1—first triode, Q2—second triode, Q3—third triode, Q4—fourth triode, D1—first diode, D2—second diode, D3—third diode, D4—fourth diode, D5—fifth diode, D6—sixth diode, D7—seventh diode, U2—first photoelectric coupler, U3—second photoelectric coupler, VCC—supply voltage, and VIN—input voltage.

### DETAILED DESCRIPTION OF THE EMBODIMENTS

In order to make the above objectives, features, and advantages of the present disclosure more apparent and more comprehensible, specific embodiments of the present disclosure are described in detail below with reference to the accompanying drawings.

Hereinafter, technical solutions of the present disclosure are further described by the specific embodiments of the present disclosure in combination with the accompanying drawings, but the present disclosure is not limited to these embodiments.

### Embodiment

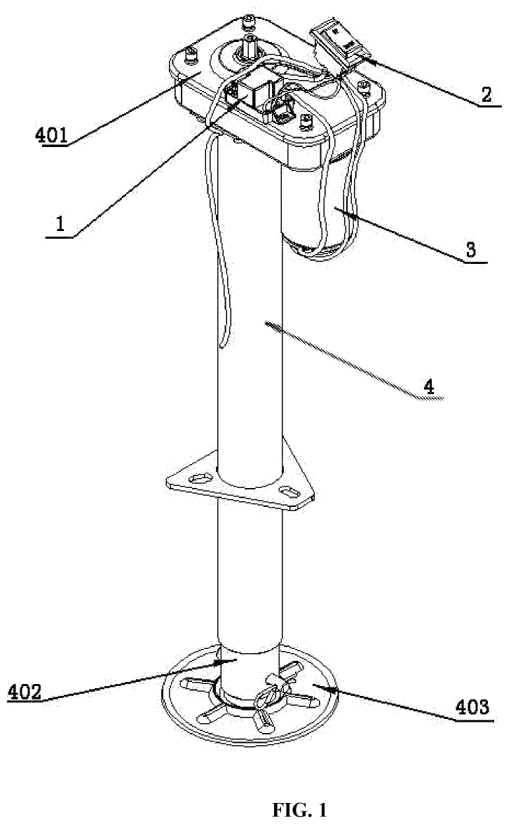

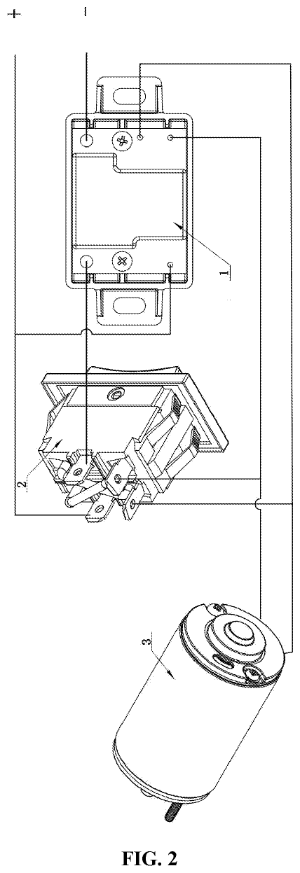

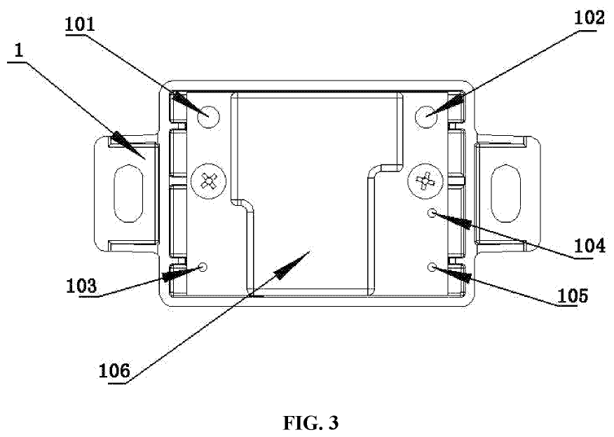

The present embodiment provides an electric jack with a current limiting protector, as shown in FIG. 1, FIG. 2, and FIG. 3, including a current limiting protector 1, a four-pin double-reset switch 2, a control motor 3, and a supporting leg main body 4.

The current limiting protector 1 is connected in parallel with the control motor 3 through the four-pin double-reset switch 2. The current limiting protector 1, the four-pin double-reset switch 2, and the control motor 3 are detachably mounted on the supporting main body 4.

A first wiring terminal 101, a second wiring terminal 102, a third wiring terminal 103, a fourth wiring terminal 104, a fifth wiring terminal 105, and a current limiting protection circuit 106 are distributed on the current limiting protector 1.

The first wiring terminal 101 is connected to a negative electrode of the four-pin double-reset switch 2. The second wiring terminal 102 is grounded. The third wiring terminal 103 is connected to an input end of a power supply in parallel with a positive electrode of the four-pin double-reset switch 2. The fourth wiring terminal 104 and the fifth wiring terminal 105 are respectively connected to the control motor 3. The current limiting protection circuit 106 is configured to perform overload power-off protection on the control motor 3.

The supporting leg main body 4 includes a mounting seat 401, a telescopic component 402, and a base 403.

The four-pin double-reset switch 2 and the control motor 4 are detachably mounted on the mounting seat 401 of the supporting leg main body 4. The mounting seat 401 is fixedly connected to the base 403 through the telescopic component 402.

Specifically, over-current protection is performed on an operating current during operating of the electric jack through the current limiting protector 1. A current limiting action can be realized within an extremely short time through the current limiting protection circuit 106 on the current limiting protector 1, which avoids the damage to internal parts of the electric jack due to operation overload, and prolongs the service life of the electric jack. The first wiring terminal 101, the second wiring terminal 102, the third wiring terminal 103, the fourth wiring terminal 104, the fifth wiring terminal 105, and the current limiting protection circuit 106 are distributed on the current limiting protector 1, so that the wiring terminals are integrated and arranged on the current limiting protector 1, which facilitates the connection between the four-pin double-reset switch 2 and the control motor 3, and reduces the space occupied by modules on the electric jack.

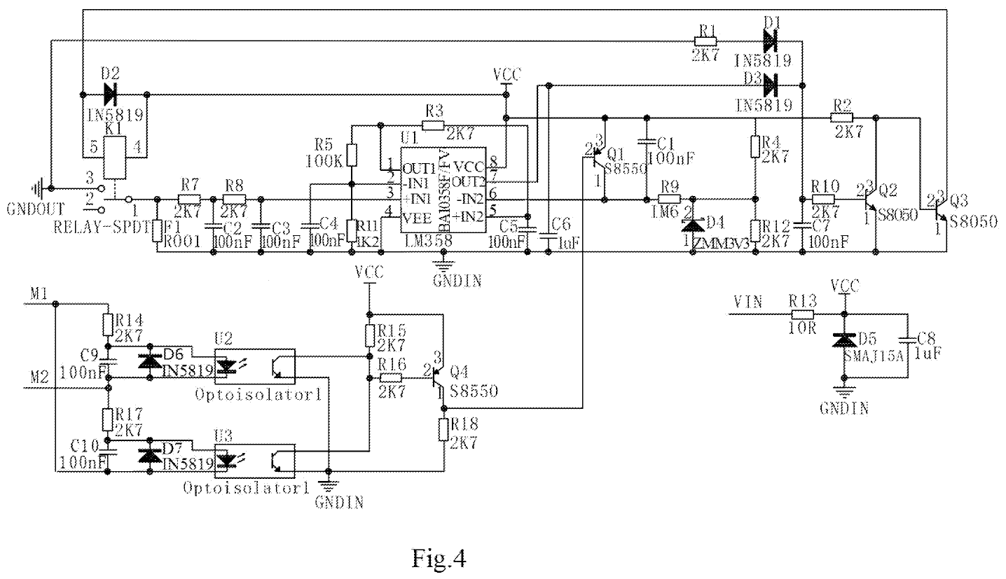

Referring to FIG. 4, the current limiting protection circuit includes an operational amplifier chip U1, a first operational amplifier circuit, a second operational amplifier circuit, a four-pin control circuit, a photoelectric isolation circuit, and a voltage stabilizing circuit.

The operational amplifier circuit and the second operational amplifier circuit are configured to buffer signal loss generated by output impedance. The four-pin control circuit control circuit is configured to control the on/off of the four-pin double-reset switch. The photoelectric isolation circuit is configured to suppress noise between the four-pin control circuit and the control motor, and eliminate the interference of a ground loop. The voltage stabilizing circuit is configured to stabilize an input voltage VIN.

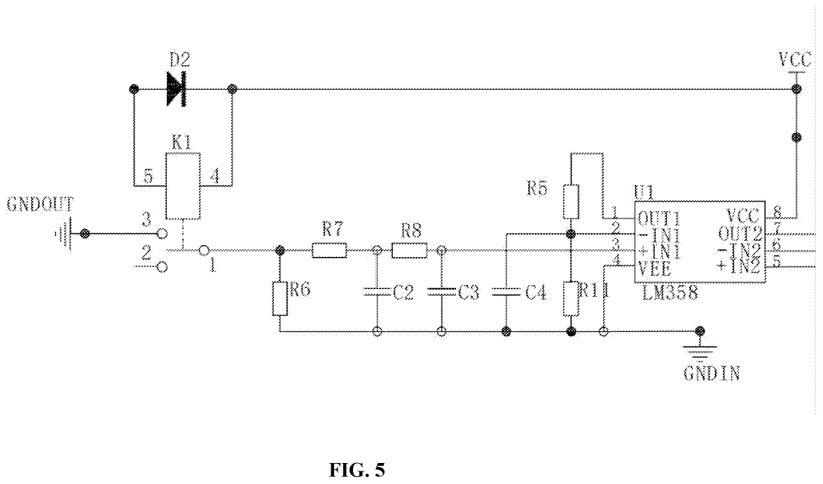

Referring to FIG. 5, a first pin, a second pin, and a third pin of the operational amplifier chip U1 form a first operational amplifier channel.

The first operational amplifier circuit consists of the first operational amplifier channel, a sixth resistor R6, an electric control switch K1, a second diode D2, a fifth resistor R5, a seventh resistor R7, an eighth resistor R8, an eleventh resistor R11, a second capacitor C2, a third capacitor C3, and a fourth capacitor C4.

The fifth resistor R5 is connected in parallel between a first pin and a second pin of the operational amplifier chip U1. The sixth resistor R6, the seventh resistor R7, the eighth resistor R8, the eleventh resistor R11, the second capacitor C2, the third capacitor C3, and the fourth capacitor C4 are connected in parallel with digital ground through the first operational amplifier channel.

The sixth resistor R6 is connected in parallel with a first pin of the electric control switch K1. A second pin of the electric control switch K1 is connected in parallel with power ground. The electric control switch K1 is connected to the supply voltage VCC in parallel with the second diode D2 through a fourth pin and a fifth pin, where the sixth resistor R6 is a sampling resistor.

Specifically, the electric control switch L1 is an electric control device, which makes the controlled quantity change in a predetermined step in an electrical output circuit when the change of an input quantity meets a specified requirement. The electric control switch has an interactive relationship between an input loop and an output loop. The electric control switch is an “automatic switch” that usually operates. The electric control switch achieves the functions of automatic adjustment, safety protection, circuit conversion, and the like.

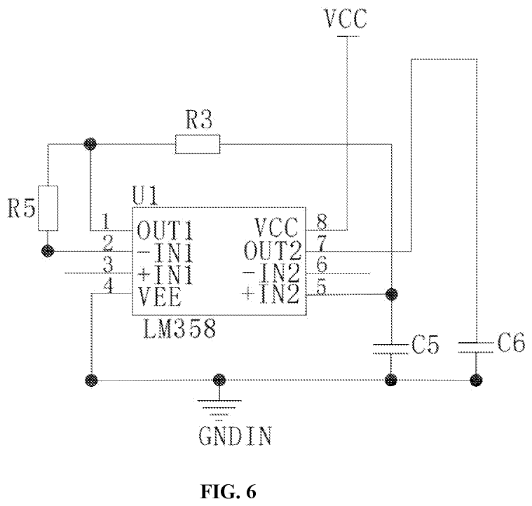

Referring to FIG. 6, a fifth pin, a sixth pin, and a seventh pin of the first operational amplifier chip U1 form a second first operational amplifier channel.

The second operational amplifier circuit consists of the second operational amplifier channel, the third resistor R3, a fifth capacitor C5, and a sixth capacitor C6. One end of the third resistor R3 is connected in parallel to the first pin of the operational amplifier chip U1 and the fifth resistor R5. The other end of the third resistor R3 is connected to The digital ground in parallel with the fifth pin of the operational amplifier chip U1 and the fifth capacitor C5. The seventh pin of the operational amplifier chip U1 is connected to the digital ground in parallel with the sixth capacitor C6.

Specifically, in the operational amplifier chip U1, the first pin is an output end. The second pin is an inverting input end. The third pin is a non-inverting input end. The fourth pin is a negative power supply. The fifth pin is a non-inverting input end. The sixth pin is an inverting input end. The seventh pin is an output end. The eighth pin is a supply voltage VCC. When a voltage at the non-inverting input end is higher than that of the inverting input end, the output is a high level. When the voltage at the non-inverting input end is lower than that of the inverting input end, the output of a voltage comparator is a low level.

Referring to FIG. 4, the four-pin control circuit is connected to the first operational amplifier channel and the second operational amplifier channel.

The four-pin control circuit consists of a first triode Q1, a second triode Q2, a third triode Q3, a fourth triode Q4, the first resistor R1, the second resistor R2, the fourth resistor R4, a ninth resistor R9, a tenth resistor R10, a twelfth resistor R12, a fifteenth resistor R15, a sixteenth resistor R16, an eighteenth resistor R18, a first diode D1, a third diode D3, a fourth diode D4, the first capacitor C1, and a seventh capacitor C7.

An emitting electrode of the first triode Q1 is connected to the supply voltage VCC in parallel with one end of the first capacitor C1 and one end of the fourth resistor R4. A sixth pin of the operational amplifier chip U1, a collecting electrode of the first triode, the fourth diode D4, the twelfth resistor R12, the other end of the first capacitor C1, and the other end of the fourth resistor R4 are connected in parallel to the digital ground. A base electrode of the first triode Q1 is connected in parallel with a collecting electrode of the fourth triode Q4 and the eighteenth resistor R18.

An emitting electrode of the fourth triode Q4 is connected to the supply voltage VCC in parallel with one end of the fifteenth resistor R15. A base electrode of the fourth triode Q4 is connected in parallel to the other end of the fifteenth resistor R15 through the sixteenth resistor R16.

A collecting electrode of the second triode Q2 is connected in parallel with each of the second resistor R2 and a base electrode of the third triode Q3. A base electrode of the second triode Q2 is connected to the digital ground in parallel with a negative electrode of the first diode D1, a negative electrode of the third diode D3 and the seventh capacitor C7 through the tenth resistor R10. A positive electrode of the first diode D1 is connected to the power ground in series with the first resistor RE A positive electrode of the third diode D3 is connected in parallel to the seventh pin of the operational amplifier chip U1.

A collecting electrode of the third triode Q3 is connected to the supply voltage VCC in parallel with the electric control switch K1 and the second diode D2. An emitting electrode of the third triode Q3 is connected to the digital ground in parallel with an emitting electrode of the second triode Q2.

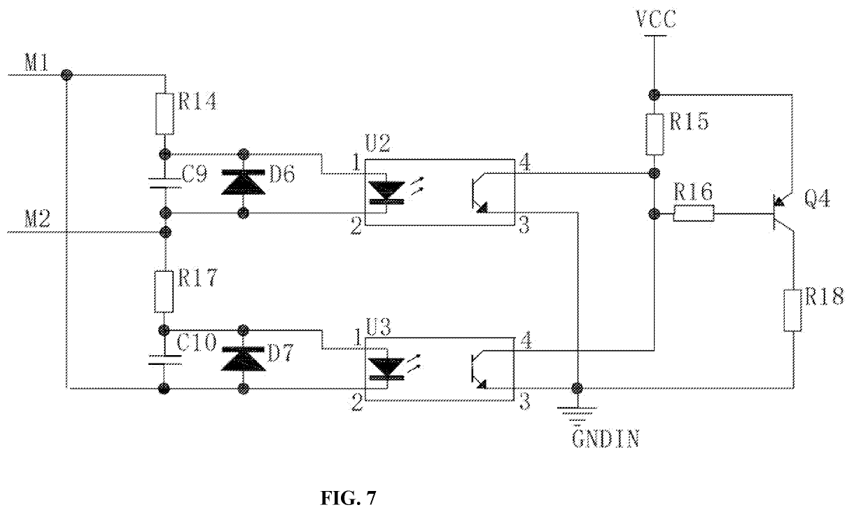

Referring to FIG. 7, the photoelectric isolation circuit consists of a first photoelectric coupler U2, a second photoelectric coupler U3, a sixth diode D6, a seventh diode D7, a fourteenth resistor R14, a seventeenth resistor R17, the ninth capacitor C9, and the tenth resistor R10.

A fourth pin of the first photoelectric coupler U2 is connected in parallel to the other end of the fifteenth resistor R15, the other end of the sixteenth resistor R16, and a fourth pin of a second photoelectric coupler U3. A third pin of the first photoelectric coupler U2 is connected to the digital ground in parallel with a third pin of the second photoelectric coupler U3 and the eighteenth resistor R18. A second pin and a first pin of the first photoelectric coupler U2 are connected to the control motor 3 in parallel with the sixth diode D6, the ninth capacitor C9, and the fourteenth resistor R14.

A second pin and a first pin of the second photoelectric coupler U3 are connected to the control motor 3 in parallel with the seventh diode D7, a tenth capacitor C10, and the seventeenth resistor R17.

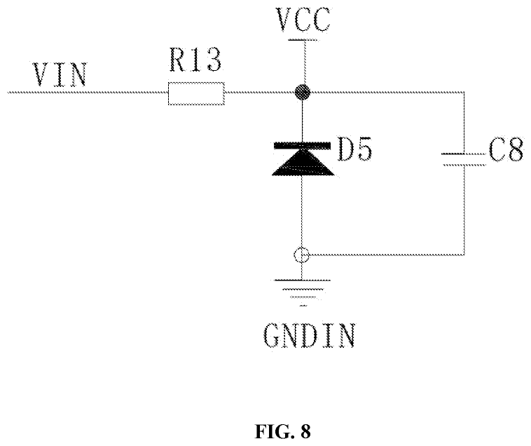

Referring to FIG. 8, the voltage stabilizing circuit consists of a fifth diode D5, an eighth capacitor C8, and a thirteenth resistor R13.

One end of the thirteenth resistor R13 is connected to the input voltage VIN. The other end of the thirteenth resistor R13 is connected to the power voltage VCC in parallel with a negative electrode of the fifth diode D5 and a positive electrode of the eighth capacitor C8. A positive electrode of the fifth diode D5 and a negative electrode of the eighth capacitor C8 are connected in parallel to the digital ground.

Specifically, the digital ground is a common reference ground wire with a zero potential of a digital circuit. The power ground is a common reference ground wire with a zero potential of a load circuit. Both the digital ground and the power ground achieve an effect of electrically isolating.

The operational amplifier chip U1 adopts an LM358 voltage follower.

Specifically, a first pin, a second pin, and a third pin of the LM358 voltage follower form the first operational amplifier channel. A fifth pin, a sixth pin, and a seventh pin of the LM358 voltage follower form a second operational amplifier channel.

The first triode Q1 and the fourth triode Q4 adopt PNP type triodes, and second triode Q2 and the third triode Q3 adopt NPN type triodes.

Referring to FIG. 4, specifically, the operational amplifier chip U1 supplies power to a voltage of 3V to 32V, which forms the first operation amplifier circuit and the second operation amplifier circuit. The input voltage VIN is stabilized through the fifth diode D5. GNDIN is the digital ground, the GNDOUT is the power ground, and the GNDIN and the GNDOUT are connected through a sampling resistor. The voltage at two ends of the sampling resistor is compared with a set voltage value through the first operational amplifier circuit and the second operational amplifier circuit, which is used to determine whether the motor is over-current. M1 and M2 are connected to the motor for determining whether the motor is operating. When and only when the motor is operating, the first operational electrical circuit and the second operational electrical circuit operate. Delay determination is realized by the first capacitor C1 and the ninth resistor R9. The first triode Q1, the second triode Q2, the third triode Q3, and the fourth triode Q4 are all used as a function of a digital switch.

According to the present disclosure, over-current protection is performed on an operating current during operating of the electric jack through the current limiting protector. A current limiting action can be realized within an extremely short time through the current limiting protection circuit on the current limiting protector, which limits the current accurately, avoids the damage to internal parts of the electric jack due to operation overload, and prolongs the service life of the electric jack. Meanwhile, there is no need to protect the parts in terms of structural strength, and the strength requirements of supporting leg components are also reduced to some extent, thereby reducing the material cost of the electric jack.

Although the present disclosure is as above, the scope of protection of the present disclosure is not limited thereto. Those skilled in the art may make various modifications and variations without departing from the spirit or scope of the present disclosure, and all of these variations and modifications will fall within the scope of protection of the present disclosure.

1. An electric jack with a current limiting protector, comprising a current limiting protector (1), a four-pin double-reset switch (2), a control motor (3), and a supporting leg main body (4), wherein
the current limiting protector (1) is connected in parallel to the control motor (3) through the four-pin double-reset switch (2); the current limiting protector (1), the four-pin double-reset switch (2), and the control motor (3) are detachably mounted on the supporting leg main body (4);
a first wiring terminal (101), a second wiring terminal (102), a third wiring terminal (103), a fourth wiring terminal (104), a fifth wiring terminal (105), and a current limiting protection circuit (106) are distributed on the current limiting protector (1);
the first wiring terminal (101) is connected to a negative electrode of the four-pin double-reset switch (2);
the second wiring terminal (102) is grounded;
the third wiring terminal (103) is connected to an input end of a power supply in parallel with a positive electrode of the four-pin double-reset switch (2);
the fourth wiring terminal (104) and the fifth wiring terminal (105) are respectively connected to the control motor (3); and
the current limiting protection circuit (106) is configured to perform overload power-off protection on the control motor (3).

2. The electric jack with the current limiting protector according to claim 1, wherein the current limiting protection circuit comprises an operational amplifier chip (U1), a first operational amplifier circuit, a second operational amplifier circuit, a four-pin control circuit, a photoelectric isolation circuit, and a voltage stabilizing circuit;
the operational amplifier circuit and the second operational amplifier circuit are configured to buffer signal loss generated by output impedance;
the four-pin control circuit control circuit is configured to control the on/off of the four-pin double-reset switch;
the photoelectric isolation circuit is configured to suppress noise between the four-pin control circuit and the control motor, and eliminate the interference of a ground loop; and
the voltage stabilizing circuit is configured to stabilize an input voltage (VIN).

3. The electric jack with the current limiting protector according to claim 2, wherein a first pin, a second pin, and a third pin of the operational amplifier chip (U1) form a first operational amplifier channel;
the first operational amplifier circuit consists of the first operational amplifier channel, a sixth resistor (R6), an electric control switch (K1), a second diode (D2), a fifth resistor (R5), a seventh resistor (R7), an eighth resistor (R8), an eleventh resistor (R11), a second capacitor (C2), a third capacitor (C3), and a fourth capacitor (C4);
the fifth resistor (R5) is connected in parallel between a first pin and a second pin of the operational amplifier chip (U1); the sixth resistor (R6), the seventh resistor (R7), the eighth resistor (R8), the eleventh resistor (R11), the second capacitor (C2), the third capacitor (C3), and the fourth capacitor (C4) are connected in parallel with digital ground through the first operational amplifier channel;
the sixth resistor (R6) is connected in parallel with a first pin of the electric control switch (K1); a second pin of the electric control switch (K1) is connected in parallel with power ground; and the electric control switch (K1) is connected to the supply voltage (VCC) in parallel with the second diode D2 through a fourth pin and a fifth pin, wherein the sixth resistor (R6) is a sampling resistor.

4. The electric jack with the current limiting protector according to claim 3, wherein a fifth pin, a sixth pin, and a seventh pin of the operational amplifier chip (U1) form a second operational amplifier channel;
the second operational amplifier circuit consists of the second operational amplifier channel, the third resistor (R3), a fifth capacitor (C5), and a sixth capacitor (C6); one end of the third resistor (R3) is connected in parallel to the first pin of the operational amplifier chip (U1) and the fifth resistor (R5); the other end of the third resistor (R3) is connected to the digital ground in parallel with the fifth pin of the operational amplifier chip (U1) and the fifth capacitor (C5); and the seventh pin of the operational amplifier chip (U1) is connected to the digital ground in parallel with the sixth capacitor (C6).

5. The electric jack with the current limiting protector according to claim 4, wherein the four-pin control circuit is connected to the first operational amplifier channel and the second operational amplifier channel;
the four-pin control circuit consists of a first triode (Q1), a second triode (Q2), a third triode (Q3), a fourth triode (Q4), the first resistor (R1), the second resistor (R2), the fourth resistor (R4), a ninth resistor (R9), a tenth resistor (R10), a twelfth resistor (R12), a fifteenth resistor (R15), a sixteenth resistor (R16), an eighteenth resistor (R18), a first diode (D1), a third diode (D2), a fourth diode (D4), the first capacitor (C1), and a seventh capacitor (C7);
an emitting electrode of the first triode (Q1) is connected to the supply voltage (VCC) in parallel with one end of the first capacitor (C1) and one end of the fourth resistor (R4); a sixth pin of the operational amplifier chip (U1), a collecting electrode of the first triode, the fourth diode (D4), the twelfth resistor (R12), the other end of the first capacitor (C1), and the other end of the fourth resistor (R4) are connected in parallel to the digital ground; a base electrode of the first triode (Q1) is connected in parallel with a collecting electrode of the fourth triode (Q4) and the eighteenth resistor (R18);
an emitting electrode of the fourth triode (Q4) is connected to the supply voltage (VCC) in parallel with one end of the fifteenth resistor (R15); a base electrode of the fourth triode (Q4) is connected in parallel to the other end of the fifteenth resistor (R15) through the sixteenth resistor (R16);
a collecting electrode of the second triode (Q2) is connected in parallel with each of the second resistor (R2) and a base electrode of the third triode (Q3); a base electrode of the second triode (Q2) is connected to the digital ground in parallel with a negative electrode of the first diode (D1), a negative electrode of the third diode (D3) and the seventh capacitor (C7) through the tenth resistor (R10); a positive electrode of the first diode (D1) is connected to the power ground in series with the first resistor (R1); a positive electrode of the third diode (D3) is connected in parallel to the seventh pin of the operational amplifier chip (U1);
a collecting electrode of the third triode (Q3) is connected to the supply voltage (VCC) in parallel with the electric control switch (K1) and the second diode (D2); and an emitting electrode of the third triode (Q3) is connected to the digital ground in parallel with an emitting electrode of the second triode (Q2).

6. The electric jack with the current limiting protector according to claim 5, wherein the photoelectric isolation circuit consists of a first photoelectric coupler (U2), a second photoelectric coupler (U3), a sixth diode (D6), a seventh diode (D7), a fourteenth resistor (R14), a seventeenth resistor (R17), the ninth capacitor (C9), and the tenth resistor (R10);
a fourth pin of the first photoelectric coupler (U2) is connected in parallel to the other end of the fifteenth resistor (R15), the other end of the sixteenth resistor (R16), and a fourth pin of a second photoelectric coupler (U3); a third pin of the first photoelectric coupler (U2) is connected to the digital ground in parallel with a third pin of the second photoelectric coupler (U3) and the eighteenth resistor (R18); a second pin and a first pin of the first photoelectric coupler (U2) are connected to the control motor (3) in parallel with the sixth diode (D6), the ninth capacitor (C9), and the fourteenth resistor (R14); and
a second pin and a first pin of the second photoelectric coupler (U3) are connected to the control motor (3) in parallel with the seventh diode (D7), a tenth capacitor (C10), and the seventeenth resistor (R17).

7. The electric jack with the current limiting protector according to claim 2, wherein the voltage stabilizing circuit consists of a fifth diode (D5), an eighth capacitor (C8), and a thirteenth resistor (R13);
one end of the thirteenth resistor (R13) is connected to the input voltage (VIN); the other end of the thirteenth resistor (R13) is connected to the power voltage (VCC) in parallel with a negative electrode of the fifth diode (D5) and a positive electrode of the eighth capacitor (C8); and a positive electrode of the fifth diode (D5) and a negative electrode of the eighth capacitor (C8) are connected in parallel to the digital ground.

8. The electric jack with the current limiting protector according to claim 2, wherein the operational amplifier chip (U1) adopts an LM358 voltage follower.

9. The electric jack with the current limiting protector according to claim 5, wherein the first triode (Q1) and the fourth triode (Q4) adopt PNP type triodes, and the second triode (Q2) and the third triode (Q3) adopt NPN type triodes.

10. The electric jack with the current limiting protector according to claim 1, wherein
the supporting leg main body (4) comprises a mounting seat (401), a telescopic component (402), and a base (403);
the four-pin double-reset switch (2) and the control motor (3) are detachably mounted on the mounting seat (401) of the supporting leg main body (4); and the mounting seat (401) is fixedly connected to the base (403) through the telescopic component (402).
